(19) United States
(12) Patent Application Publication
(10) Pub. No.: US 2010/0091501 A1
(43) Pub. Date: Apr. 15, 2010

(54) Light emitting diode apparatus and optical engine using the same

(75) Inventors: Zeu-Chia Tan, Hsin-Chu (TW); Chi-Chui Yun, Hsin-Chu (TW); Wan-Chen Lai, Hsin-Chu (TW)

Correspondence Address: BACON & THOMAS, PLLC, 625 SLATERS LANE, FOURTH FLOOR, ALEXANDRIA, VA, 22314-1176, US

(73) Assignee: Young Optics Inc., Hsin-Chu (TW)

(21) Appl. No.: 12/588,189

(22) Filed: Oct. 7, 2009

(30) Foreign Application Priority Data
Oct. 15, 2008 (TW) 097139617

(51) Int. Cl. F21V 29/00; H01J 61/52

(52) U.S. Cl. 362/294; 313/46

(57) ABSTRACT

A light emitting diode (LED) apparatus includes a heat dissipating component, a flexible circuit board, a slug, a light emitting diode die, and a package material. The flexible circuit board has a hollow-out portion disposed on the heat dissipating component. The slug is thermal conductively connected to the heat dissipating component through the hollow-out portion of the flexible circuit board. The light emitting diode die is disposed on the slug, and electrically connected to the flexible circuit board. The package material covers the light emitting diode die and the slug, and the bottom thereof is connected to the flexible circuit board. The light emitting diode apparatus is applied to an optical engine having a chassis and a top cover. The flexible circuit board of the light emitting diode apparatus is assembled on the chassis, and the heat dissipating component thereof is assembled on the top cover.

### BACKGROUND OF THE INVENTION

(1) Field of the Invention

The invention relates to a light source apparatus, and more particularly relates to a light emitting diode apparatus.

(2) Description of the Prior Art

Heat dissipating effect is an important factor influencing luminous efficiency of light emitting diode (LED). Especially when the light emitting diode is applied to a small-sized mobile apparatus, the influence of heat dissipating effect is more significant. Moreover, the stability of the luminous efficiency of the light emitting diode apparatus is influenced by the structure intensity.

Referring to FIG. 1, a conventional light emitting diode apparatus 100 includes a light emitting diode die 120, a slug 140, a plurality of welding points 160, a package material 180, a flexible cable 130, and a heat-sink plate 110. The light emitting diode die 120, the slug 140, and the welding points 160 are packaged into a body by the package material 180. The light emitting diode die 120 is disposed on the slug 140.

As FIG. 1 shows, the heat-sink plate 110 is attached to the bottom of the slug 140 and bottoms of several welding points 160. Thus, heat generated by the light emitting diode die 120 is conducted to the heat-sink plate 110 through the slug 140 to achieve heat dissipating effect.

The flexible cable 130 is disposed at one side of the heat-sink plate 110, connected to the bottom of the package material 180 by a few welding points 160, so the weld strength is low. If the products using the light emitting diode 100 fall on ground or are placed in a vibrant environment for long time, the flexible cable 130 may be bent easily or the welding points 160 tend to depart from the flexible cable 130 under the bump or the drag of a generated lateral force F, and the problems of bad contact or short circuit may be generated.

Refer to FIG. 2 for a schematic view of another conventional light emitting diode apparatus 200. A light emitting diode die 220, a slug 240, and welding points 260 are packaged into a body by a package material 280. The slug 240 and the welding points 260 are fixed on an upside of a flexible cable 230, and a heat-sink plate 210 is attached to an underside of the flexible cable 230. Heat generated by the light emitting diode die 220 is conducted to the flexible cable 230 through the slug 240 and then to the heat-sink plate 210. The flexible cable 230 has a high thermal resistance with an insulation layer (not shown), and therefore the light emitting diode die 220 may be hard to dissipate heat and the luminous efficiency of the light emitting diode die 220 may be reduced.

In the light emitting diode apparatus 200, the flexible cable 230 is fixed on the bottom of the slug 240 and bottoms of the welding points 260. Since the bottom of the slug 240 and the bottoms of the welding points 260 are at the same level, to prevent the flexible cable 230 from bending or breaking off may be difficult in the process of producing the light emitting diode apparatus 200. When the light emitting diode apparatus 200 is applied in handheld electronic products, users may throw down carelessly or the products are placed in the car bumping on the rugged road, and the flexible cable 130 may be broken off due to bump or drag of the lateral force F.

### SUMMARY OF THE INVENTION

The invention is to provide a light emitting diode apparatus and an optical engine using the light emitting diode apparatus and capable of preventing the flexible circuit board of the light emitting diode apparatus from falling off due to bending, bump or drag.

Other objectives, features and advantages of the present invention will be further understood from the further technological features disclosed by the embodiments of the present invention wherein there are shown and described preferred embodiments of this invention, simply by way of illustration of modes best suited to carry out the invention.

In order to achieve one or part of or all the objectives or other objectives, a light emitting diode apparatus of an embodiment of the present invention is provided. The light emitting diode apparatus includes a heat dissipating component, a flexible circuit board, and a light emitting diode package unit. The flexible circuit board has a hollow-out portion disposed on the heat dissipating component. The light emitting diode package unit is disposed on the flexible circuit board, and includes a light emitting diode die, a slug, and a package material. The slug is thermal conductively connected to the heat dissipating component through the hollow-out portion of the flexible circuit board. The light emitting diode die is disposed on the slug and electrically connected to the flexible circuit board. The package material covers the light emitting diode die and the slug, and has a bottom connected to the flexible circuit board.

The flexible circuit board has a conductive layer, an insulation layer, and a thermal interface material layer. The conductive layer electrically is electrically connected to the light emitting diode die. The insulation layer is disposed between the conductive layer and the thermal interface material layer. The thermal interface material layer is thermal conductively connected to the slug and the heat dissipating component. The thermal interface material layer is, for example, a graphite layer, a copper layer or an aluminum layer.

In an embodiment, the hollow-out portion of the flexible circuit board penetrates the conductive layer, the insulation layer, and the thermal interface material layer. A metal wire is disposed inside the hollow-out portion, so as to be thermal conductively connected to the heat dissipating component and the slug.

In an embodiment, the light emitting diode package unit further includes at least two welding pads disposed on the bottom of the package material and adjacent to the boundary of the bottom, wherein the thickness of the welding pads protruding out of the bottom is smaller than the thickness of the slug protruding out of the bottom. Thus, if the hollow-out portion of the flexible circuit board penetrates the conductive layer, the insulation layer, and the thermal interface material layer, the slug is embedded into the hollow-out portion of the flexible circuit board and contacts a surface of the heat dissipating component. If the hollow-out portion penetrates the conductive layer and the insulation layer, then the slug is embedded into the hollow-out portion to contact the thermal interface material layer, so as to be thermal conductively connected to the heat dissipating component through the thermal interface material layer.

According to an embodiment of the present invention, an optical engine is provided. The optical engine includes a chassis, a lens module, an image module, abovementioned light emitting diode apparatus, and a top cover. The lens module and the image module are fixed on the chassis and in a light path, and covered by the top cover. The light emitting diode apparatus is used to provide a light beam traveling along the light path and through the lens module and the image module. The flexible circuit board of the light emitting diode apparatus is disposed on the chassis. The heat dissipating component is jointed to the top cover.

In an embodiment, the light emitting diode package unit includes a red light emitting diode package unit, a green light emitting diode package unit, and a blue light emitting diode package unit. These light emitting diode package units are disposed on the flexible circuit board for emitting different color lights. The flexible circuit board has a plurality of gaps, and each of the gaps is disposed between two adjacent the light emitting diode package units. The heat dissipating component has an interval separating the heat dissipating component into a first heat dissipating area and a second heat dissipating area, wherein the red light emitting diode package unit is disposed in the first heat dissipating area, and the green light emitting diode package unit and the blue light emitting diode package unit are disposed in the second heat dissipating area.

The light emitting diode apparatus of the above embodiment has a good heat dissipating path and structure intensity. With the additional thermal interface material layer, the thermal conduction resistance and the thermal dissipation resistance between the slug and the flexible circuit board may be lowered down. The flexible circuit board of the light emitting diode apparatus is assembled on the chassis of the optical engine, and the heat dissipating component is jointed to the top cover, so that heat generated by the light emitting diode die is conducted quickly to the top cover and the chassis through the heat dissipating component and the flexible circuit board.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic view of a conventional light emitting diode apparatus.

FIG. 2 is a schematic view of a conventional light emitting diode apparatus.

FIG. 3A is an exploded view of a light emitting diode apparatus according to an embodiment of the present invention.

FIG. 3B is an exploded view of the light emitting diode apparatus according the embodiment of to the present invention.

FIG. 3C is a schematic view of the light emitting diode apparatus according to the embodiment of the present invention.

FIG. 4 is a stereogram of the light emitting diode apparatus according to the embodiment of the present invention.

FIG. 5 is a schematic view of a light emitting diode apparatus according to an embodiment of the present invention.

FIG. 6 is a schematic view of a light emitting diode apparatus according to an embodiment of the present invention.

FIGS. 7A and 7B are schematic views showing applications of the light emitting diode apparatus according to the embodiment of the present invention.

FIGS. 8 and 9 are schematic views of a optical engine according to an embodiment of the present invention.

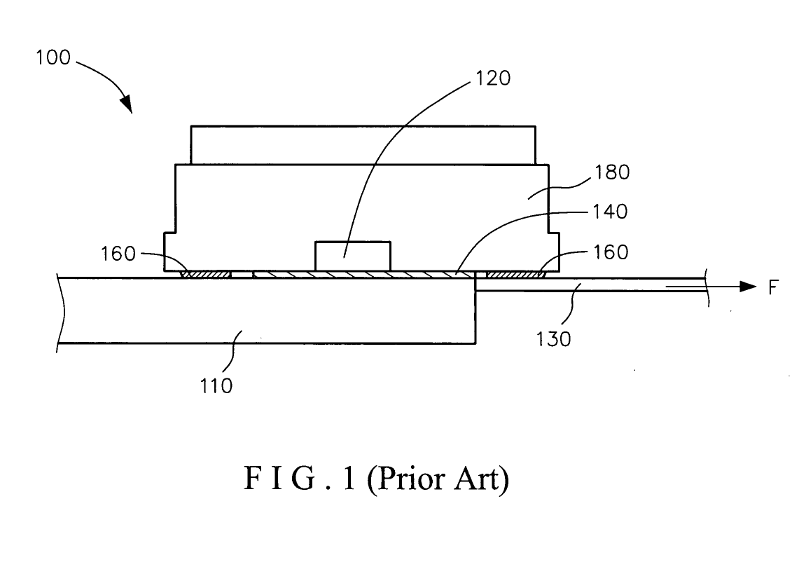

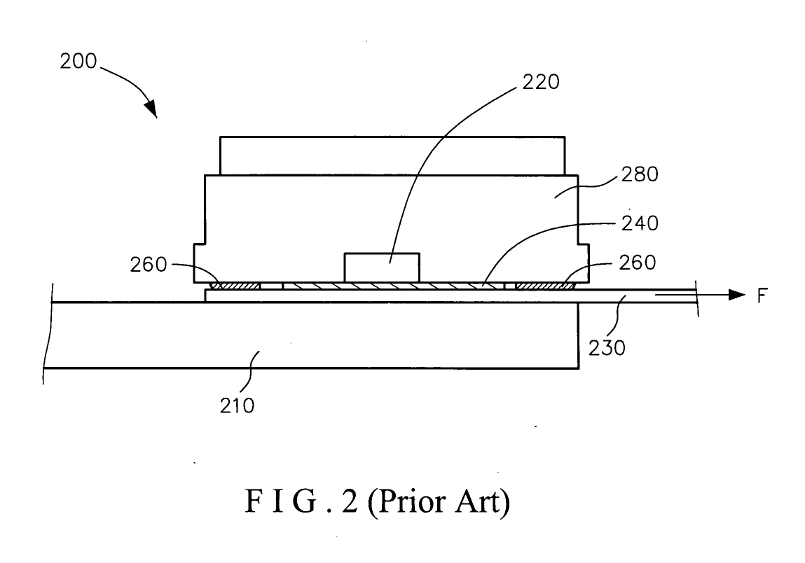

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

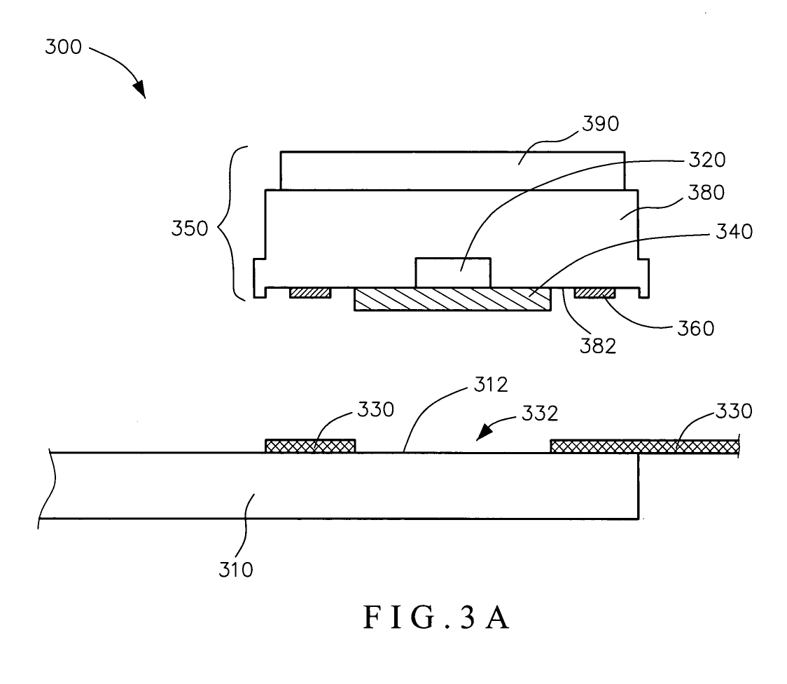

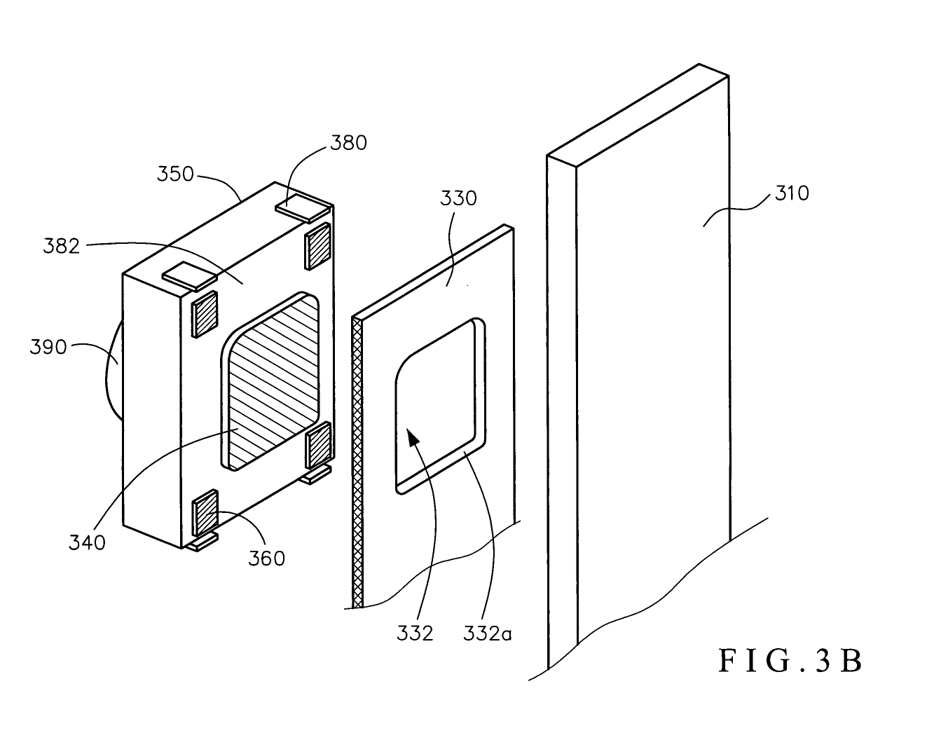

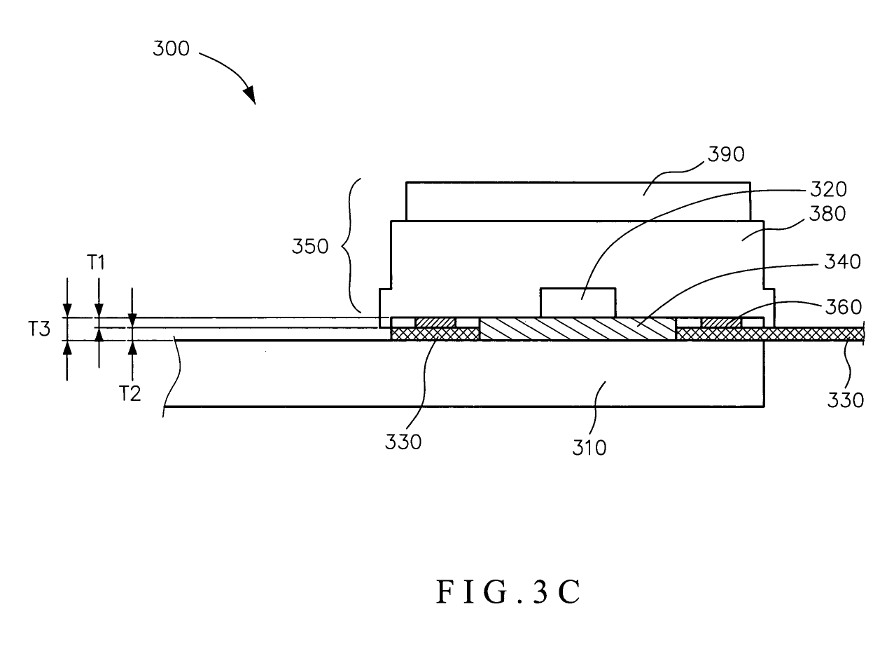

Referring to FIG. 3A, a light emitting diode apparatus 300 of an embodiment of the present invention includes a heat dissipating component 310, a flexible circuit board 330, and a light emitting diode package unit 350. The flexible circuit board 330 is disposed on the heat dissipating component 310 and has a hollow-out portion 332. A surface 312 of the heat dissipating component 310 is exposed through the hollow-out portion 332. When the light emitting diode package unit 350 is disposed on the flexible circuit board 330, a slug 340 may contact the heat dissipating component 310.

The light emitting diode package unit 350 includes a light emitting diode die 320, a slug 340, a plurality of welding pads 360, and a package material 380. The light emitting diode die 320 is disposed on the slug 340, and the slug 340 is made of the material with high thermal resistance, such as copper. Thus, heat generated by the light emitting diode die 320 is conducted by the slug 340. The package material 380 packs the light emitting diode die 320, the slug 340, and the welding pads 360 into the light emitting diode package unit 350.

The package material 380 has a bottom 382, and a glass cover 390 is disposed on the package material 380. Light beams from the light emitting diode die 320 emit through the glass cover 390. The welding pads 360 are disposed on the bottom 382 of the package material 380, adjacent to the boundary of the bottom 382. The slug 340 protrudes out of the bottom 382 of the package material 380 to be embedded into the hollow-out portion 332 of the flexible circuit board 330, and is thermal conductively connected to the surface 312 of the heat dissipating component 310 exposed through the hollow-out portion 332.

Referring to FIG. 3B, when fabricating the light emitting diode apparatus 300, a layer of the package material 380 on the bottom of the light emitting diode package unit 350 is removed by polishing to make the slug 340 further protrude out of the bottom 382 of the package material 380. Then part of the flexible circuit board 330 is hollowed out and attached to the bottom of the light emitting diode package unit 350. When attaching, the flexible circuit board 330 is fixed on the welding pads 360. The slug 340 is embedded into the hollow-out portion 332 of the flexible circuit board 330 and fixed in an inner margin 332a of the hollow-out portion 332. The heat dissipating component 310 is provided to be attached to the flexible circuit board 330 and connected to the slug 340.

Referring to FIG. 3C, in the light emitting diode apparatus 300 after fabricated, the slug 340 is embedded in the hollow-out portion 332 of the flexible circuit board 330 and thermal conductively connected to the surface 312 of the heat dissipating component 310. In an embodiment, the slug 340 is also a electric conductor. The positive electrode (not shown) of the light emitting diode die 320 is electrically connected to the flexible circuit board 330 via the slug 340, and the negative electrode (not shown) of the light emitting diode die 320 is electrically connected to the flexible circuit board 330 via the welding pads 360. In this way, the light emitting diode die 320 receives electrical signals through the flexible circuit board 330. The package material 380 covers the light emitting diode die 320, the slug 340, the welding pads 360, and part of the flexible circuit board 330, and the bottom 382 of the package material 380 is connected to the flexible circuit board 330 via the welding pads 360.

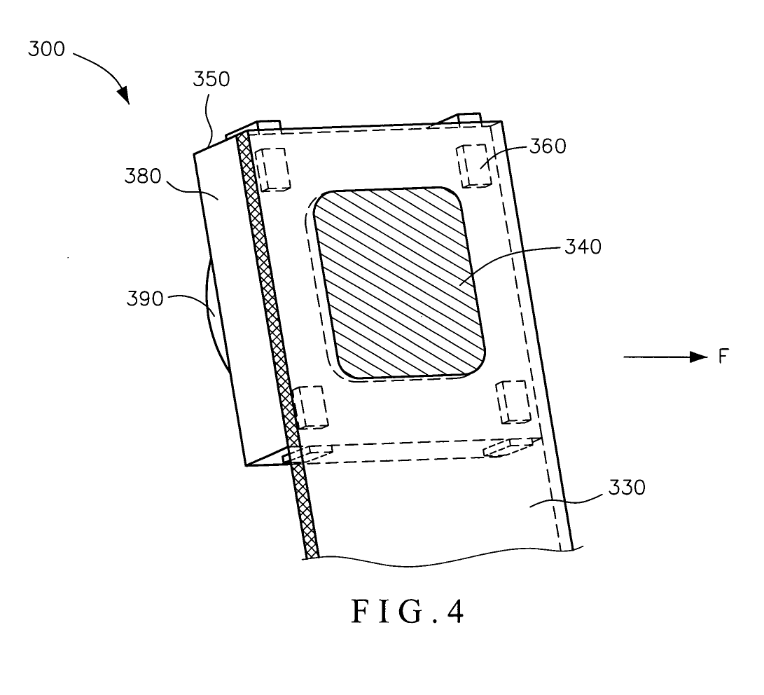

Refer to FIG. 4 for an exploded view of the light emitting diode apparatus 300 according to the embodiment of the present invention. For convenience, FIG. 4 omits the heat dissipating component 310. The bottom 382 of the package material 380 of the light emitting diode package unit 350 in the present embodiment is sunken deeply enough relative to the slug 340 to hold the flexible circuit board 330. The hollow-out portion 332 in the middle of the flexible circuit board 330 makes the light emitting diode package unit 350 and the flexible circuit board 330 embedded into each other. The slug 340 restraints the lateral movement of the flexible circuit board 330, and the fixture intensity of the flexible circuit board 330 may be enhanced, so that the flexible circuit board 330 may be not loose even pulled by a lateral force F.

As FIG. 3C and FIG. 4 show, there are at least two welding pads 360 at the bottom of the light emitting diode package unit 350. Number of the welding pads 360 depends on the shape of the light emitting diode package unit 350 and the request of the welding intensity. For example, if the shape of the light emitting diode package unit 350 is square, hexagonal or octagonal, the number of the welding pads is 4, 6 or 8 accordingly. To improve the welding intensity between the flexible circuit board 330 and the light emitting diode package unit 350, the welding pads 360 are distributed evenly at the boundary of the bottom 382 of the package material 380.

As FIG. 3C shows, thickness T1 of the welding pad 360 protruding out of the bottom 382 of the package material 380 is smaller than thickness T3 of the slug 340 protruding out of the bottom 382 of the package material 380, and the thickness T3 of the slug 340 approximately equals to the sum of the thickness T1 of the welding pad 360 and the thickness T2 of the flexible circuit board 330. In this way, the bottoms of the slug 340 and the flexible circuit board 330 are approximately at the same level to make the heat dissipating component 310 closely attach to the slug 340 of the light emitting diode package unit 350 to enhance heat dissipating efficiency.

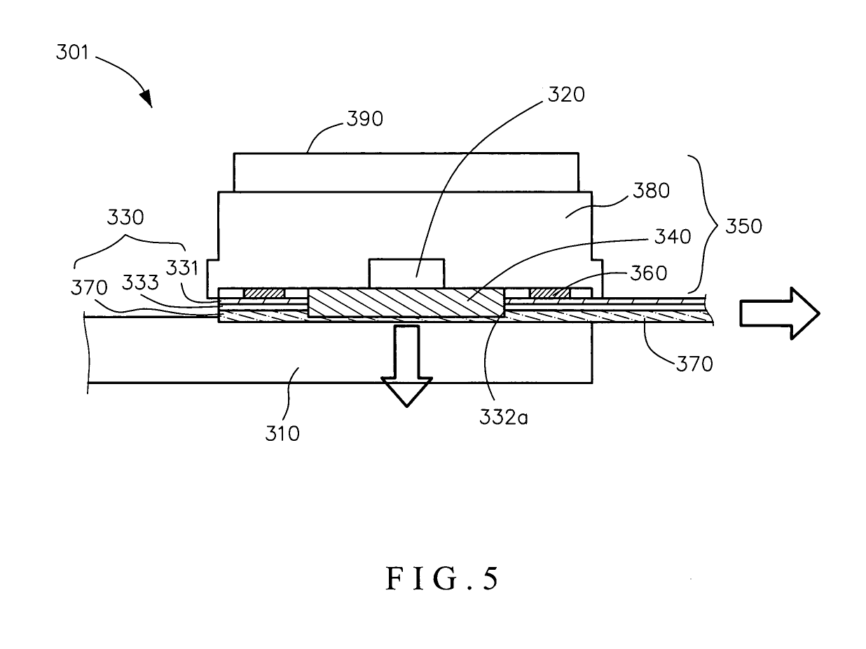

Referring to FIG. 5, in an embodiment, the flexible circuit board 330 of the light emitting diode apparatus 301 includes a conductive layer 331, an insulation layer 333, and a thermal interface material layer 370. The conductive layer 331 is electrically connected to the light emitting diode die 320 through the welding pads 360. Both thicknesses of the welding pad 360 and the slug 340 protruding out of the bottom 382 of the package material 380 are the same as FIG. 3C shows. The insulation layer 333 is disposed between the conductive layer 331 and the thermal interface material layer 370. The thermal interface material layer 370 is attached to the bottom of the insulation layer 333 and thermal conductively connected to the slug 340 and the heat dissipating component 310, to reduce the thermal conduction resistance and the thermal dissipation resistance between the slug 340 and the heat dissipating component 310 or between the slug 340 and the flexible circuit board 330. Thus, the light emitting diode die 320 may use not only the heat dissipating component 310 (downward arrow) but also the thermal interface material 370 (rightward arrow) to conduct heat.

As FIG. 5 shows, the hollow-out portion 332 and the inner margin 332a of the flexible circuit board 330 penetrate only the conductive layer 331 and the insulation layer 333 rather than the thermal interface material 370, so the slug 340 contacts the thermal interface material layer 370 and is thermal conductively connected to the heat dissipating component 310 via the thermal interface material layer 370 after the slug 340 is embedded into the hollow-out portion 332. The test result of the heat dissipating effect of the light emitting diode apparatus 300 in FIG. 5 is as follows. The temperature of the light emitting diode package unit 350 may be lowered about 12-15□ when the power consumption is 2 watt.

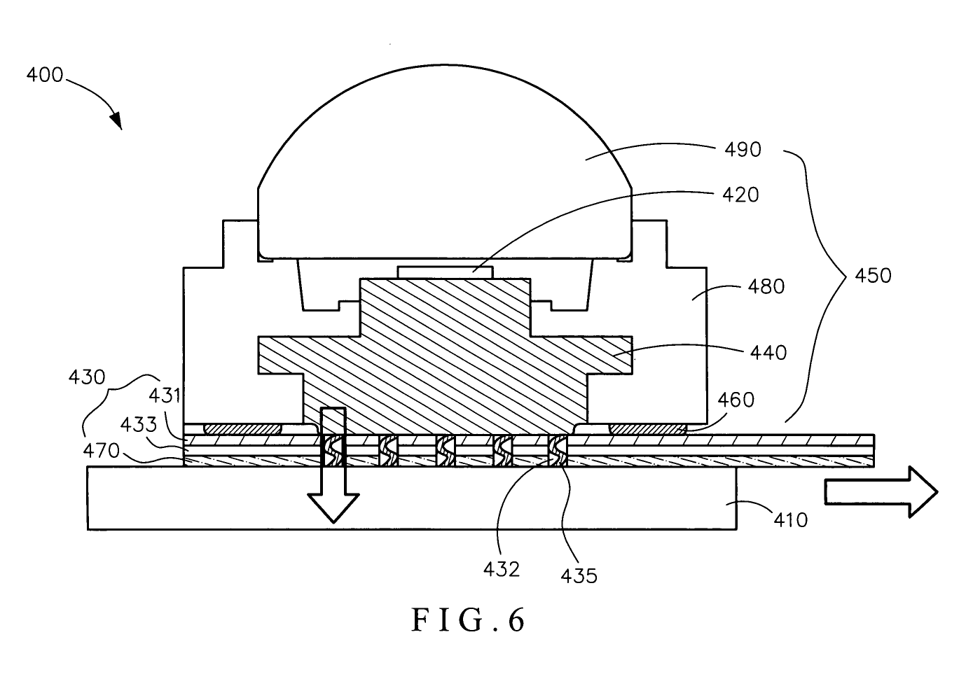

Referring to FIG. 6, in an embodiment, a light emitting diode apparatus 400 includes a heat dissipating component 410, a light emitting diode package unit 450, and a flexible circuit board 430 including a conducting layer 431, an insulation layer 433, and a thermal interface material 470. The light emitting diode package unit 450 includes a light emitting diode die 420, a slug 440, a plurality of welding pads 460, and a package material made up of a packaging colloid 480 and a glass cover 490. The flexible circuit board 430 is disposed on the heat dissipating component 410 and has a hollow-out portion 432. A surface of the heat dissipating component 410 is exposed through the hollow-out portion 432. The light emitting diode package unit 450 is disposed on the flexible circuit board 430 and contacts the heat dissipating component 410.

Different from FIG. 5, the hollow-out portion 432 of the flexible circuit board 430 penetrates the conducting layer 431, the insulation layer 433, and the thermal interface material layer 470. A metal wire 435 is disposed inside the hollow-out portion 432, such as a copper wire. The metal wire 435 is thermal conductively connected to the heat dissipating component 410, the slug 440, and the thermal interface material layer 470 to reduce the thermal resistance for dissipating heat swiftly. Thus, a via structure constituted by the hollow-out portion 432 and the metal wire 435 therein is used to conduct heat to avoid bad heat dissipation due to the high thermal resistance of the insulation layer 433. In this way, the slug 440 conducts heat downward to the heat dissipating component 410 and rightward along the thermal interface material layer 470.

In the above embodiments, the package material 380 may be ceramic or plastic. The heat dissipating component 310 may be a heat-sink plate, and the flexible circuit board 330 may be a flexible cable or a flexible printed circuit (FPC).

The thermal interface material layer 370 may be a graphite layer. Graphite has a high effective thermal conduction with plane thermal conductivity K=800 W/mK and vertical thermal conductivity K=7 W/mK, and the graphite layer may be made into a thin layer with thickness of 0.08 mm. Due to the pliability of the graphite layer, the graphite layer is suitable to couple with the flexible circuit board 330 to act as the thermal interface material layer 370 between the light emitting diode package unit 350 and the heat dissipating component 310. In addition, the thermal interface material layer 370 may also be material of high thermal dissipation rate, such as copper or aluminum, made in a thin layer with thickness of 0.02 mm.

Because the thermal interface material 370 is a thin layer, the embodiments of the present invention may not be restrained by a small space of a handheld projection device when the embodiment of the present invention is applied to a light emitting diode apparatus of the handheld projection device. In addition, if the present embodiment is used in a light emitting diode package unit with high watt, there may be no need to add extra space to dispose other extra heat dissipating components.

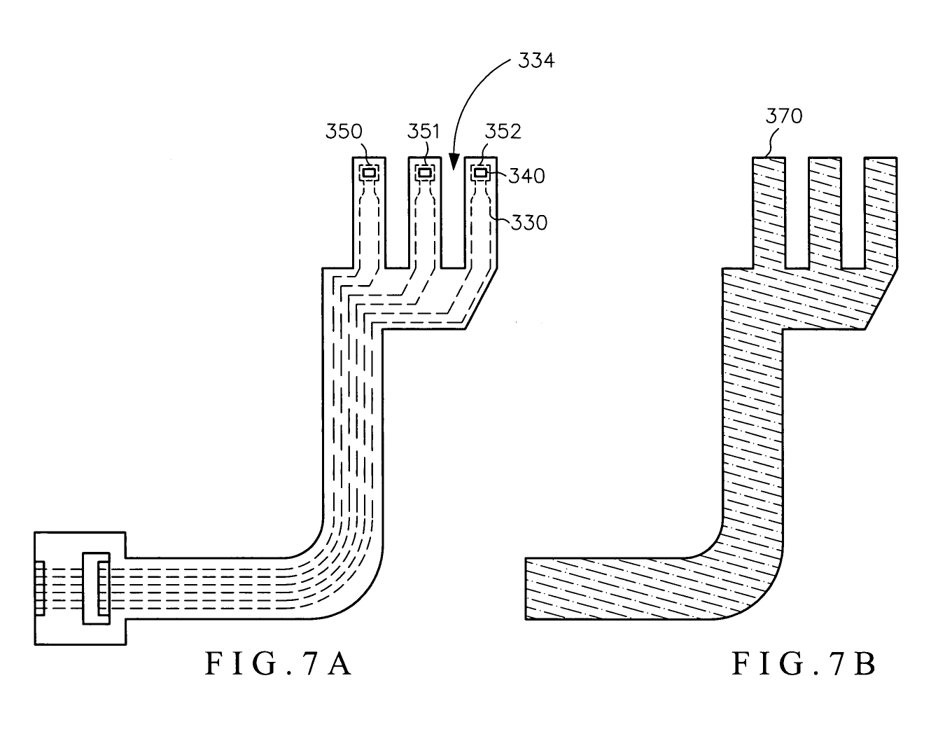

Refer to FIG. 7A for an application of an embodiment of the present invention. A plurality of light emitting diode package units 350, 351, and 352 capable of emitting different colors are disposed on the same flexible circuit board 330. The flexible circuit board 330 may be in an irregular shape with a plurality of through holes or hollow-out portion 332 for embedding the slugs 340 of the light emitting diode package units 350, 351, and 352 inside. In an embodiment, the light emitting diode package units 350, 351, and 352 are a red light emitting diode package unit, a green light emitting diode package unit, and a blue light emitting diode package unit respectively. The flexible circuit board 330 has a plurality of gaps 334, and each of the gaps 334 is disposed between the adjacent light emitting diode package units 350, 351, and 352.

Referring to FIG. 7B, the shape of the thermal interface material layer 370 is designed to match the flexible circuit board 330 to be attached on the slugs 340 of the flexible circuit board 330 and the light emitting diode package units 350, 351, and 352 in FIG. 7A.

The light emitting diode apparatus 300 of the above embodiment has a good heat dissipating path and structure intensity. With the additional thermal interface material layer 370, the thermal conduction resistance and the thermal dissipation resistance may be lowered down quickly. Counting on the pliability of the thermal interface material layer 370, the thermal interface material 370 may not be restrained by the heat dissipating space of the handheld product.

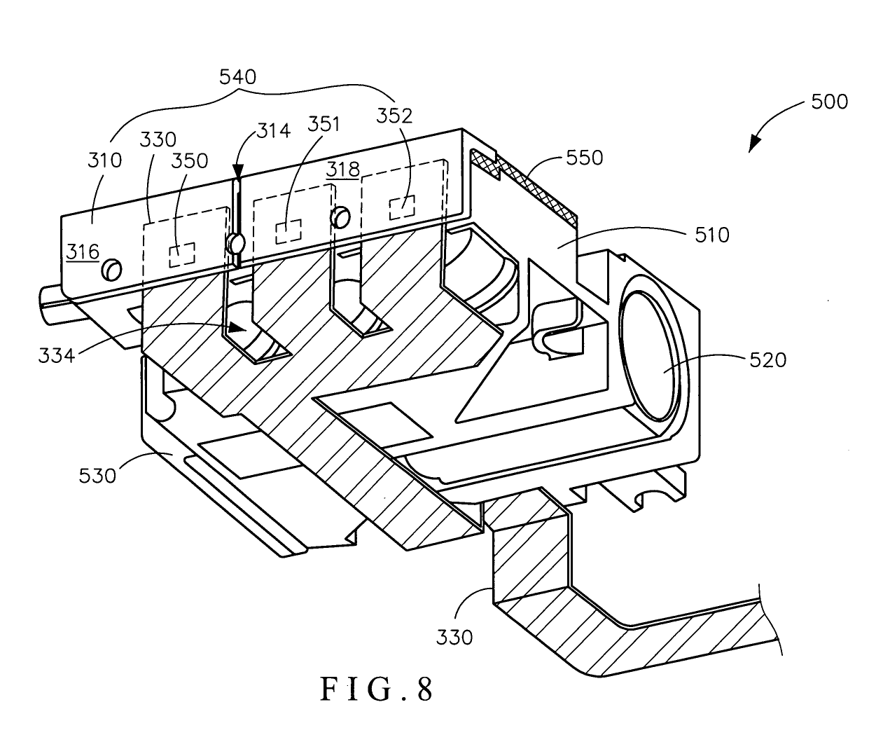

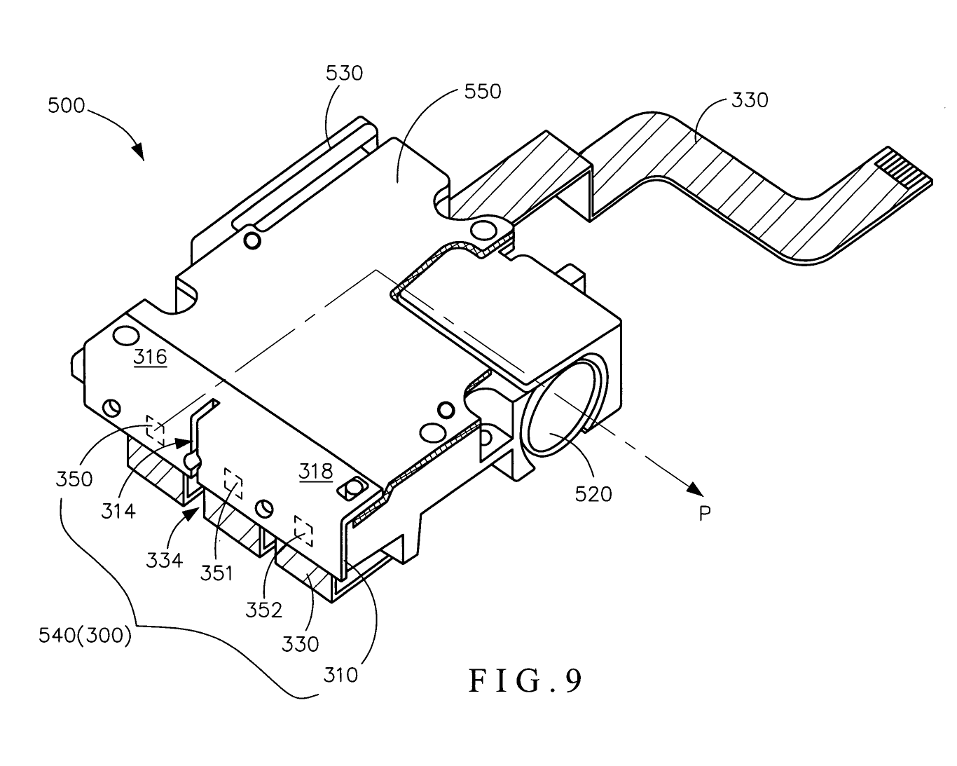

Referring to FIGS. 8 and 9, an optical engine 500 has a chassis 510, a lens module 520, an image module 530, a light emitting diode apparatus 540, and a top cover 550. The lens module 520, the image module 530, and the light emitting diode apparatus 540 are all disposed on the chassis 510 and located in the same light path. FIG. 9 is a schematic view of a light path P. The light emitting diode apparatus 540 is capable of providing a light beam traveling along the light path P and passing the lens module 520 and the image module 530. The light emitting diode apparatus 540 may applies abovementioned light emitting diode apparatus 300, 301 or 400. In fabrication, the light emitting diode apparatus 540 is formed by attaching the thermal interface material 370 in FIG. 7B on the structure of FIG. 7A. Additionally, the flexible circuit board 330 is less restricted by the heat dissipating space due to the plurality of the flexible circuit board 330. Besides, the flexible circuit board 330 may be attached under the chassis 510 of the optical engine 500, and the flexible circuit board 330 may also be attached to other components of the projector, such as housing, so as to save space.

In the embodiment, heat generated from the light emitting diode package units 350, 351, and 352 is conducted to the chassis 510 via the flexible circuit board 330 quickly. The gap 334 may effectively isolate the heat generated from the light emitting diode package units 350, 351, and 352 from conducting between each other, so as to enhance the luminous efficiency of the light emitting diode package units 350, 351 and 352.

As FIG. 9 shows, the heat dissipating component 310 of the light emitting diode apparatus 540 is assembled on the top cover 550 to cover the lens module 520 and the image module 530. In this embodiment, the heat dissipating components 310 is a single sheet metal part, and the heat dissipating components 310 is used as a fixing interface and a thermal conduction interface of the light emitting diode package units 350, 351 and 352.

Because the decline rate of the temperature and the illuminance of the red light emitting diode package unit 350 is the most, to avoid the red light emitting diode package unit 350 from being thermally influenced by the green light emitting diode package unit 351 and the blue light emitting diode package unit 352 is needed. In this embodiment, the heat dissipating components 310 of the light emitting diode apparatus 540 has an interval 314, and the interval 314 separates the heat dissipating components 310 into a first heat dissipating area 316 and a second heat dissipating area 318. The red light emitting diode package unit 350 is disposed in the first heat dissipating area 316, and the green light emitting diode package unit 351 and the blue light emitting diode package unit 352 are disposed in the second heat dissipating area 318.

By the gap 334 of the flexible circuit board 332 and the interval 314 of the heat dissipating component 310, without increasing the number of components and the difficulty of assembly, the heat is conducted to the top cover 550, while the red light emitting diode package unit 350 is not thermally influenced by the green light emitting diode package unit 351 and the blue light emitting diode package unit 352, so that the luminous efficiency of the red light emitting diode package unit 350 is enhanced.

Test result of the optical engines 500 in FIGS. 8 and 9 is as follows. Taking the red light emitting diode package unit 350 with power of 2.14 watt for example, the temperature of the slug is greatly reduced by 12□ and the luminous efficiency is enhanced about 13%.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light emitting diode apparatus, comprising:
a heat dissipating component;
a flexible circuit board, having a hollow-out portion disposed on the heat dissipating component;
a slug, thermal conductively connected to the heat dissipating component through the hollow-out portion of the flexible circuit board;
a light emitting diode die, disposed on the slug and electrically connected to the flexible circuit board; and
a package material, covering the light emitting diode die and the slug, and the package material having a bottom connected to the flexible circuit board.

2. The light emitting diode apparatus of claim 1, wherein the flexible circuit board has a conductive layer, an insulation layer, and a thermal interface material layer, the conductive layer is electrically connected to the light emitting diode die, the insulation layer is disposed between the conductive layer and the thermal interface material layer, and the thermal interface material layer is thermal conductively connected to the slug and the heat dissipating component.

3. The light emitting diode apparatus of claim 2, wherein the hollow-out portion of the flexible circuit board penetrates the conductive layer, the insulation layer, and the thermal interface material layer, a metal wire is disposed inside the hollow-out portion, so as to be thermal conductively connected to the heat dissipating component and the slug.

4. The light emitting diode apparatus of claim 2, wherein the thermal interface material layer comprises a graphite layer.

5. The light emitting diode apparatus of claim 2, wherein the thermal interface material layer comprises a copper layer or an aluminum layer.

6. The light emitting diode apparatus of claim 1, further comprising at least two welding pads disposed on the bottom of the package material and adjacent to the boundary of the bottom, wherein the thickness of the welding pads protruding out of the bottom is smaller than the thickness of the slug protruding out of the bottom.

7. The light emitting diode apparatus of claim 6, wherein the slug is embedded into the hollow-out portion of the flexible circuit board and contacts a surface of the heat dissipating component.

8. The light emitting diode apparatus of claim 6, wherein the flexible circuit board has a conductive layer, an insulation layer, and a thermal interface material layer, the conductive layer is electrically connected to the light emitting diode die, the insulation layer is disposed between the conductive layer and the thermal interface material layer, the hollow-out portion penetrates the conductive layer and the insulation layer, and the slug is embedded into the hollow-out portion to contact the thermal interface material layer, so as to be thermal conductively connected to the heat dissipating component through the thermal interface material layer.

9. An optical engine, comprising:
a chassis;
a lens module, fixed on the chassis and in a light path;
an image module, fixed on the chassis and in the light path;
a light emitting diode apparatus, capable of providing a light beam traveling along the light path and through the image module and the lens module, comprising:
a heat dissipating component;
a flexible circuit board, disposed on the chassis, and having a hollow-out portion fixed on the heat dissipating component; and
at least one light emitting diode package unit, disposed on the flexible circuit board, and comprising a light emitting diode die, a slug, and a package material, the light emitting diode die disposed on the slug, the package material covering the light emitting diode die and the slug and having a bottom connected to the flexible circuit board, and the slug protruding out of the bottom of the package material and thermal conductively connected to the heat dissipating component through the hollow-out portion of the flexible circuit board; and
a top cover, jointed to the heat dissipating component of the light emitting diode apparatus and covering the lens module and the image module.

10. The optical engine of claim 9, wherein the flexible circuit board has a conductive layer, an insulation layer, and a thermal interface material layer, the conductive layer is electrically connected to the light emitting diode die, the insulation layer is disposed between the conductive layer and the thermal interface material layer, and the thermal interface material layer is thermal conductively connected to the slug and the heat dissipating component.

11. The optical engine of claim 10, wherein the hollow-out portion of the flexible circuit board penetrates the conductive layer, the insulation layer, and the thermal interface material layer, and a metal wire is disposed inside the hollow-out portion, so as to be thermal conductively connected to the heat dissipating component and the slug.

12. The optical engine of claim 10, wherein the thermal interface material layer comprises a graphite layer.

13. The optical engine of claim 10, wherein the thermal interface material layer comprises a copper layer or an aluminum layer.

14. The optical engine of claim 9, wherein the light emitting diode package unit comprises at least two welding pads disposed on the bottom of the package material and adjacent to the boundary of the bottom, the thickness of the welding pads protruding out of the bottom is smaller than the thickness of the slug protruding out of the bottom, and the light emitting diode package unit is connected to the flexible circuit board by the two welding pads.

15. The optical engine of claim 14, wherein the slug of the light emitting diode package unit is embedded into the hollow-out portion of the flexible circuit board and contacts a surface of the heat dissipating component.

16. The optical engine of claim 14, wherein the flexible circuit board has a conductive layer, an insulation layer, and a thermal interface material layer, the conductive layer is electrically connected to the light emitting diode die, the insulation layer is disposed between the conductive layer and the thermal interface material layer, the hollow-out portion penetrates the conductive layer and the insulation layer, and the slug is embedded into the hollow-out portion to contact the thermal interface material layer, so as to be thermal conductively connected to the heat dissipating component through the thermal interface material layer.

17. The optical engine of claim 9, wherein the at least one light emitting diode package unit comprises a plurality of light emitting diode package units disposed on the flexible circuit board for emitting different color lights, and the flexible circuit board has a plurality of gaps, each of the gaps is disposed between two adjacent the light emitting diode package units.

18. The optical engine of claim 17, wherein the heat dissipating component of the light emitting diode apparatus has an interval separating the heat dissipating component into a first heat dissipating area and a second heat dissipating area, and the light emitting diode package unit comprises a red light emitting diode package unit, a green light emitting diode package unit, and a blue light emitting diode package unit, wherein the red light emitting diode package unit is disposed in the first heat dissipating area, the green light emitting diode package unit and the blue light emitting diode package unit are disposed in the second heat dissipating area.
